(19) United States
(12) Patent Application Publication
(10) Pub. No.: US 2013/0242105 A1
(43) Pub. Date: Sep. 19, 2013

(54) SYSTEM AND METHOD FOR VIDEO RECORDING AND WEBCASTING SPORTING EVENTS

(71) Applicant: H4 ENGINEERING, INC., San Antonio, TX (US)

(72) Inventors: Christopher T. Boyle, San Antonio, TX (US); Scott K. Taylor, San Antonio, TX (US); Alexander G. Sammons, San Antonio, TX (US)

(73) Assignee: H4 ENGINEERING, INC., San Antonio, TX (US)

(21) Appl. No.: 13/801,336

(22) Filed: Mar. 13, 2013

Related U.S. Application Data
(60) Provisional application No. 61/610,459, filed on Mar. 13, 2012.
(60) Provisional application No. 61/610,470, filed on Mar. 14, 2012.

(51) Int. Cl. H04N 7/18

(52) U.S. Cl. CPC H04N 7/181
USPC 348/157

(57) ABSTRACT

Systems and methods are described for automatic video recording of sporting events involving multiple participants.

### CROSS-REFERENCE TO RELATED APPLICATIONS

This application claims the benefit of U.S. Provisional Patent Application No. 61/610,459, filed Mar. 13, 2012, titled “Apparatus and Method for Webcasting and Video Recording Sporting Events Organized In Heats”, and U.S. Provisional Patent Application No. 61/610,470, filed Mar. 14, 2012, titled “Method of Advertising Using Automated Video Recording”, the contents of both of which are hereby incorporated by reference in their entirety and are not admitted to be prior art with respect to the present invention by the mention in this cross-reference section.

### BACKGROUND

This invention relates to recording multiple participants involved an activity, such as a sports activity. Recording the participants involved in the activity is a difficult task. For some activities, not all participants may be active at a given time. Additionally, a person may wish to view a particular activity occurring at an event when they are not present at the event. Even if the person is at the event, they may miss a particular participant's performance because they are not looking or too far away to see it (and thus lose the chance to experience it). Thus, a need exists for systems and methods which permit recording of multiple participants engaged in an activity that may be viewable by others which solves the aforementioned problems.

### SUMMARY OF THE INVENTION

In accordance with a preferred embodiment hereof, this invention provide a system for automatic video recording of multiple subjects, the system comprising a plurality of remote devices, a base station, and at least one recording unit, wherein each one of the plurality of remote devices is collocated with one of the multiple subjects, each one of the plurality of remote devices is communicatively coupled with the base station, and the base station controls the at least one recording unit.

In accordance with another preferred embodiment hereof, this invention provides system for recording a sporting event with multiple participants, the system comprising one or more camera banks, wherein each the camera bank comprises at least one recording unit, the at least one recording unit comprising at least one camera, wherein the at least one camera of the at least one recording unit is capable of being automatically oriented at one or more of the multiple participants, and wherein the camera banks are controlled by a recording center communicatively coupled with the camera banks.

In accordance with another preferred embodiment hereof, this invention provides a method of automatically recording a sporting event with at least one participant, wherein the location of the at least one participant is variable during recording, the method comprising the steps of enabling recording by a recording system comprising a base station, at least one recording unit, and a remote device for, and collocated with, each participant; establishing unique communication between each remote device and the base station; communicating each participant's variable location data to the base station; computing variable camera orientations and recording-unit-to-remote-device distances for each participant; sending commands from the base station for adjusting orientation, turning velocity, zoom, and focus for each recording unit according to each participant's variable location and velocity; and recording images of at least one participant at variable locations.

This invention also provides each and every novel feature, element, combination, step, and/or method disclosed or suggested herein.

### BRIEF DESCRIPTION OF THE DRAWINGS

FIG. 1 shows a schematic diagram illustrating a preferred embodiment of an automatic video recording system according to a preferred embodiment of the present invention.

FIG. 2 shows a schematic diagram illustrating a single camera embodiment of an automatic video recording system filming multiple subjects according to a preferred embodiment of the present invention.

FIG. 3 shows a schematic diagram illustrating a multi-camera embodiment of an automatic video recording system according to a preferred embodiment of the present invention.

FIG. 4 shows a schematic diagram illustrating an automatic video recording system comprising a recording unit controlled by a base station according to a preferred embodiment of the present invention.

FIG. 5 shows a schematic diagram illustrating a multi camera bank embodiment according to a preferred embodiment of the present invention.

FIG. 6 shows a flowchart illustrating a method of using automatic video recording systems of the present invention.

FIG. 7 shows a schematic diagram illustrating a recording center and its connected components according to a preferred embodiment of the present invention.

### DETAILED DESCRIPTION OF THE PREFERRED EMBODIMENTS

The systems and methods hereof relate to recording sporting events using automatic video recording systems. One preferred use of the system hereof is to record outdoor sporting events in which weather and/or terrain are important so that stationary cameras are inadequate to capture the movements of the participants. Some of the best examples of such outdoor sporting events include surfing and kiteboarding. Other examples include football and soccer where many of subjects are on a field. The systems and methods hereof include the ability to make videos for live broadcast and for saving, editing, and markup of the videos for many additional applications. It is noted that the systems and methods hereof could be used for indoor or other activities as well.

One particular preferred application of the systems and methods hereof is surfcam video streaming over the Internet. Currently, surfcam videos are videos captured by one or more substantially stationary wide-angle cameras set up at surfing venues which webcast substantially in real time. A surfcam video generally captures the current conditions of the surf at that location; the videos may or may not show a person actually surfing. A surfcam video may occasionally zoom in on a spot or pan across the surf area in the hope of better illustrating the quality of the surf or the conditions at the break of waves. Surfcam videos are typically webcast on websites or mobile device applications (referred to as “apps”) that inform surfers about the conditions to attract them to the locale. The surfcam videos attract viewers and are a tool for advertising surfing locales and local services (e.g., accommodations and surf shops). Using the systems and methods hereof significantly enhances the content and nature of surfcam videos. The systems and methods hereof permit high quality recording of professional or local surfers, competitions, and even training sessions. The systems and methods hereof permit webcasting surfcam videos that focus on activity rather than substantially static images of a locale. Accordingly, the videos generated with the systems and methods hereof are more interesting, and, thus, have the potential to be viewed by a larger audience and for a longer period of time than traditional surfcam videos. The systems and methods hereof may be applied to other sporting activities, including, for example, kiteboarding, skiing, snowboarding, and many others. The systems and methods hereof allow a greatly increased potential for using videos recorded with the systems hereof as vehicles for advertisement of a wide variety of goods and services.

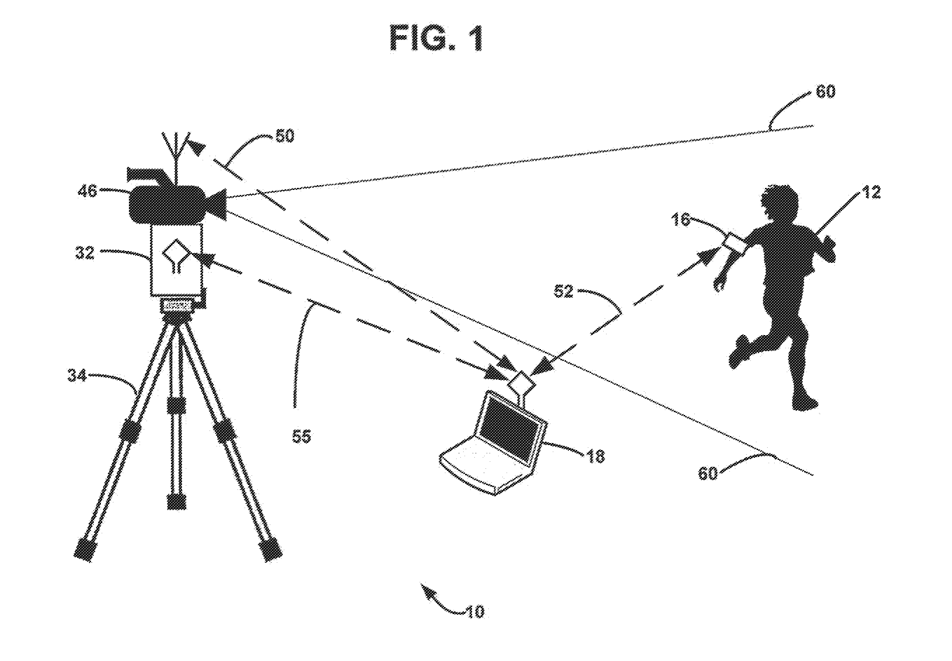

FIG. 1 shows a schematic diagram illustrating a preferred embodiment of an automatic video recording system according to a preferred embodiment of the present invention. Automatic video recording system 10 of FIG. 1 is configured to track and record a subject 12 who may be a participant in a sporting event. Automatic video recording system 10 preferably comprises remote device 16 (collocated with subject 12), one camera 46, positioner 32 (to which camera 46 is connected), and base station 18. Positioner 32 comprises mechanical and electromechanical components to orient camera 46 to stay pointed at remote device 16. Base station 18 preferably determines the pointing direction, focus, and zoom of camera 46, such that the field of view 60 includes subject 12 even as he or she moves around.

For a detailed discussion of the operation and implementation of automatic video recording system 10 refer to co-owned and co-pending U.S. patent application Ser. No. 13/726,203, filed Dec. 23, 2012, titled “Portable System for High Quality Video Recording; co-owned and co-pending U.S. patent application Ser. No. 13/782,862, filed Mar. 1, 2013, titled “Apparatus and Method for Automatic Video Recording”; and co-owned and co-pending U.S. patent application Ser. No. 13/784,536, filed Mar. 4, 2013, titled “Multifunction Automatic Video Recording Device”; the contents of all of which are hereby incorporated by reference in their entirety.

Base station 18, positioner 32, and remote device 16 all comprise communication devices and antennas so that they may communicate with one another. In FIG. 1, communication between base station 18 and camera is depicted as communication 50; communication between base station 18 and remote device 16 is depicted as communication 52; and communication between base station 18 and positioner 32 is depicted as communication 55. It is noted that in some embodiments of the present invention, camera 46 may receive and send communication via positioner 32, or not at all.

As shown in FIG. 1, base station 18 is depicted as a computer. Base station 18 is preferably equipped with appropriate communication devices and appropriately programmed to command positioner 32 and camera 46. Alternatively, base station 18 may be a dedicated device. Remote device 16 and positioner 32 each comprise antennas, transceivers, and microcontrollers. Remote device 16 also comprises one or more positioning devices such as a global positioning antenna and/or radiation sources for line-of-sight positioning (for details regarding these location determination methods, refer to the patent applications incorporated by reference above). Positioner 32 may also comprise one or more positioning devices such as a global positioning antenna and/or radiation detectors for line-of-sight positioning. Positioner 32 preferably comprises one or more motors that turn camera 46 in the direction of remote device 16 such that subject 12 remains within the field of view 60 of camera 46 (and of the resulting recorded footage) as he or she moves around during his/her sporting activity.

As FIG. 1 shows, subject 12 wears or otherwise has remote device 16 that enables locating of the subject by base station 18.

As subject 12 moves in the environment, the location of remote device 16 is communicated to base station 18 which communicates with positioner 32 to turn camera 46 so that camera 46 remains pointed at remote device 16 thereby keeping subject 12 in the field of view of the camera. Base station 18 and remote device 16 are preferably paired, meaning that they communicate exclusively with each other. Communication between these devices may be coded such that communication from and to other similar devices does not interfere with a paired set of remote device 16 and base station 18.

As shown in FIG. 1, positioner 32 and camera 46 are connected with tripod 34.

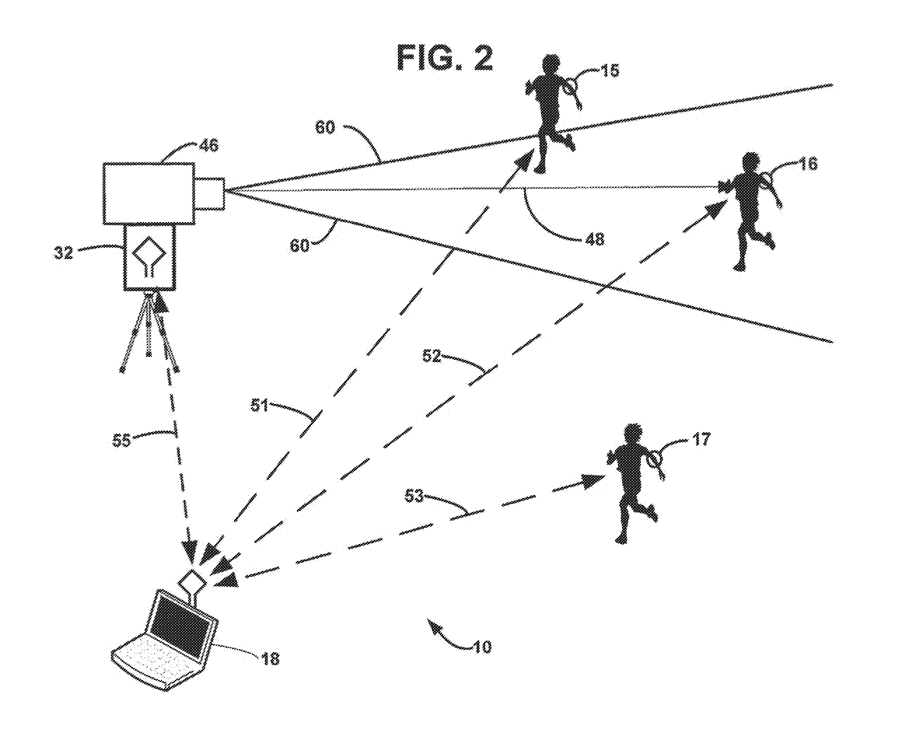

FIG. 2 shows a schematic diagram illustrating a single camera embodiment of an automatic video recording system filming multiple subjects according to a preferred embodiment of the present invention. In FIG. 2, automatic video recording system 10 comprises one positioner 32 and one camera 46 (and base station 18 communicatively coupled to positioner 32 and multiple remote devices [remote devices 15, 16, and 17]) to track and record multiple subjects each wearing a remote device. Communication between base station 18 and remote device 15 is depicted as communication 51. Communication between base station 18 and remote device 16 is depicted as communication 52. Communication between base station 18 and remote device 17 is depicted as communication 53.

When multiple remote devices are in the vicinity of base station 18 sending radio signals, base station 18 must be able to recognize from which remote device the communication packets are sent. In one preferred embodiment, at the startup of automatic video recording system 10, the various different remote devices are assigned different codes; base station 18 sends and receives the remote-device-specific code with each communication packet. Camera 46 is oriented by positioner 32. Since the single camera shown in FIG. 2 cannot separately track each remote device, base station 18 allows for user input wherein the user input may be in the form of a computer software program that allows the user to input or select information about the event filmed. For example, one may select the timing of the appearance of different participants in a competition. In such a situation, base station 18 commands positioner 32 to track one specific remote device 16 at a time. In another preferred embodiment the base station 18 is programmed to orient camera 46 to follow and record always the participant who, based on the location of the associated remote device, is the closest to the camera.

In a preferred embodiment, with reference to remote device 16, the locations of the remote device 16 and camera 46 are known based on global positioning signal reception. As the subject moves, base station 18 receives communication 52 from remote device 16 that includes location data and relative position pointing vector 48 is calculated. Alternative methods of determining relative position pointing vector 48 include using line of sight technology, visual recognition methods using image recognition software, or additional devices such as accelerometers, gyroscopes, and barometric sensors. All such methods, including global positioning, may be used in various combinations or individually, and are collectively referred for convenience as Location Determination Technology. Remote device 16 preferably comprises hardware appropriate to the type of Location Determination Technology used. For example, remote device 16 may comprise a global positioning antenna, infrared and/or visible light sources, etc. In a preferred embodiment, remote device 16 is powered by a battery and it is built using technology that makes it waterproof and shockproof. Remote device 16 may be wearable using a strap, belt, or other fastener. Remote device 16 may be worn attached to an arm, to an article of clothing, to headgear, to a leg, or to an ankle. Remote device 16 may be integrated into an article of headgear, carried in a pocket, etc.

When global positioning technology is used to determine the locations of a camera and multiple remote devices, during setup of the system, the remote devices are collocated with the camera. If the global positioning antennas of the remote devices had infinitely good precision, they would indicate the same location at this time. However, the precision of the global positioning systems and antennas is finite and it is likely that the locations of the remote devices will appear somewhat different due to random errors. In case of systems or applications where a single remote device is used, this results in an error bubble that, especially when the subject is close to the camera, may be significant. When multiple remote devices are used, averaging of their apparent locations and assigning the average location as the location of the camera reduces the error in its location.

Base station 18 preferably outputs positioning commands (turning angle and turning velocity commands) to positioner 32 and camera operation commands (focusing and zooming commands) to camera 46 directly or through positioner 32. As a result of these commands, positioner 32 causes camera 46 to point along relative pointing vector 48 at remote device 16; camera 46 focuses at the distance between remote device 16 and camera 46, and the zoom of the camera 46 is set such that the field of view of the camera 46 is larger than the subject. An appropriate process optimizes the size of the field of view (which is a compromise between the desire to zoom in as much as possible (and to show as much detail as possible) and keeping the subject within the shot without excessively rapid camera movements).

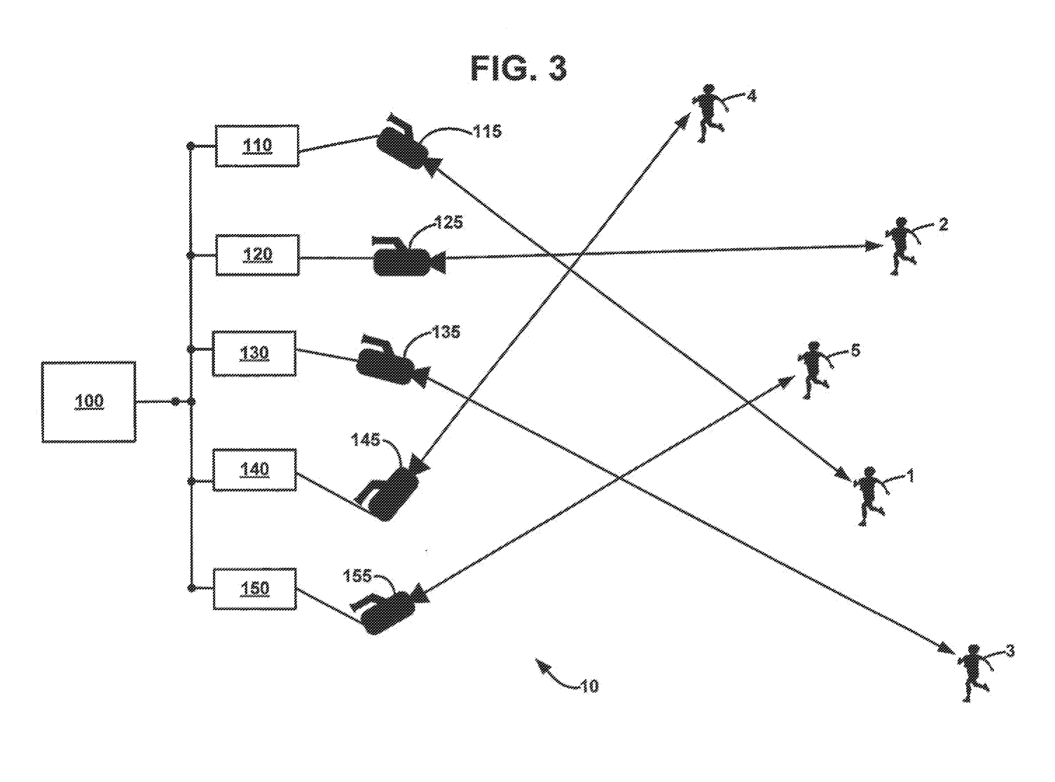

FIG. 3 shows a schematic diagram illustrating a multi-camera embodiment of an automatic video recording system according to a preferred embodiment of the present invention. More particularly, FIG. 3 shows five subjects (subjects 1, 2, 3, 4, and 5) being recorded by automatic video recording system 10. The subjects may be, for example, participants in a heat of a competition. A heat is an event in which there are at least two competitors performing simultaneously. Five cameras (cameras 115, 125, 135, 145, and 155) are each oriented at a corresponding subject along position vectors between each camera and subject. FIG. 3 does not illustrate the distances between the cameras in proportion to the distances between the cameras and the subjects (the latter distances are typically much larger than the distances between the cameras).

Each camera tracks and is oriented towards a corresponding subject or participant by a corresponding positioner 110, 120, 130, 140, and 150. All positioners are controlled by a base station 100 and provide feedback to base station 100. There are also direct camera controls for focusing and zooming from the base station 100 to each of the cameras.

The system of FIG. 3 permits recording each subject separately. The recorded video footage may be broadcast for real time viewing at another location or stored for later editing. If broadcast, a user preferably has an interface where they can select which subject's camera footage to show.

While FIG. 3 shows five subjects or participants, it is noted that any number of subjects may be tracked and recorded.

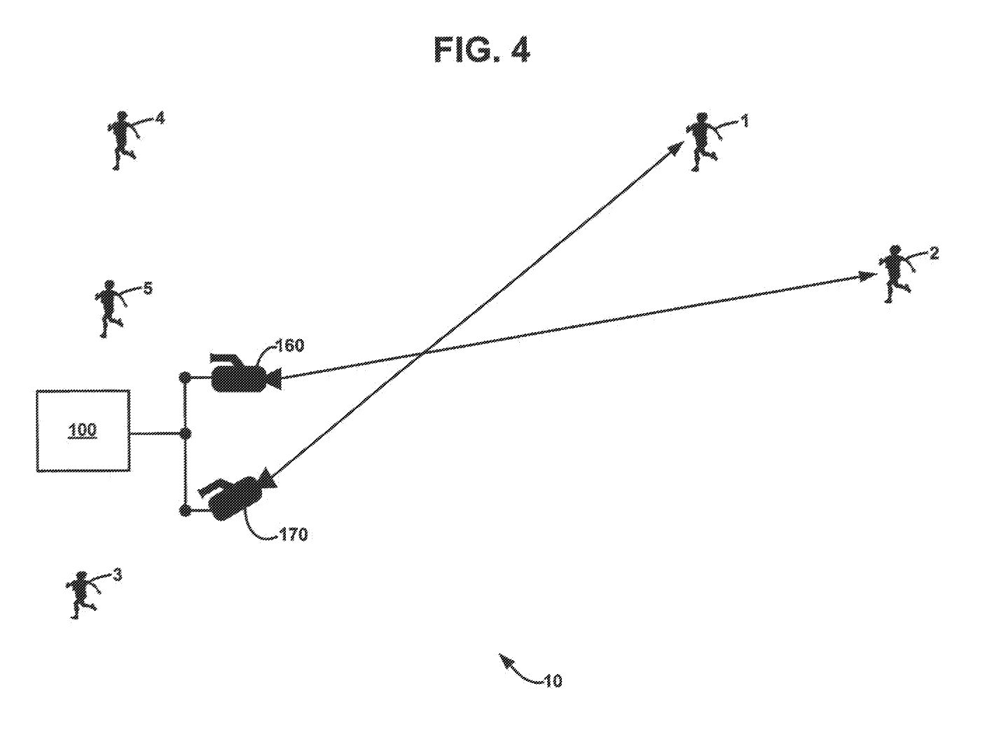

FIG. 4 shows a schematic diagram illustrating an automatic video recording system comprising a recording unit controlled by a base station according to a preferred embodiment of the present invention.

In certain competitions (such as kite boarding), two competitors compete per heat and the competitors move freely and unpredictably within a fairly large area. Using the embodiment illustrated in FIG. 4, the competitors are preferably filmed using two recording units, each recording unit comprising a camera and a positioner.

Automatic video recording system 10, as shown in FIG. 4, is set up to record an event in which there are two competitors per heat, i.e., there are two active competitors. In FIG. 4, the active competitors are competitors 1 and 2. All competitors, including competitors 3, 4, and 5 are equipped with remote devices, but base station 100 is programmed, in keeping with the competition schedule (or by operator entered commands), to film competitors 1 and 2 who are competing in the current heat. Two recording units, 160 and 170, are shown in FIG. 4. As noted above, each recording unit comprises a camera and a positioner. Each recording unit receives commands from base station 100, and, in FIG. 4, the cameras are oriented each at one of the active competitors. It should be noted that the system may be arranged to track and record more than two active competitors, more than five competitors, etc. It is further noted that the remote devices may be passed from one competitor to another as the competition progresses. Remote devices may be worn using armbands and the like. Remote devices may also be attached to lycra suits, leggings, shirts, and the like, and may be passed from competitor to competitor during a competition.

When the heat ends, the recording units may continue tracking and recording the participants, the recording units may be turned off, or they may be programmed to start recording other participants. The footage recorded may include sound recorded either by the operator of the system or some other person observing the heat, or the sound may come from sound recorded by the remote devices, or both. The recording may be streamed live to websites and/or television viewers, or it may be saved for later editing and/or broadcasting.

Base station 100 may be a computer and the scenario depicted in FIG. 4 (and likewise in FIG. 3) may be shown on a screen of that computer. A pointing device (mouse, or, in case of a touchscreen, a finger) may be used to control, i.e., establish and remove, connections between recording units and remote devices. The computer screen may show a realistic view of the relative locations of all recording units and remote devices to help the operator make decisions regarding choosing subjects for recording.

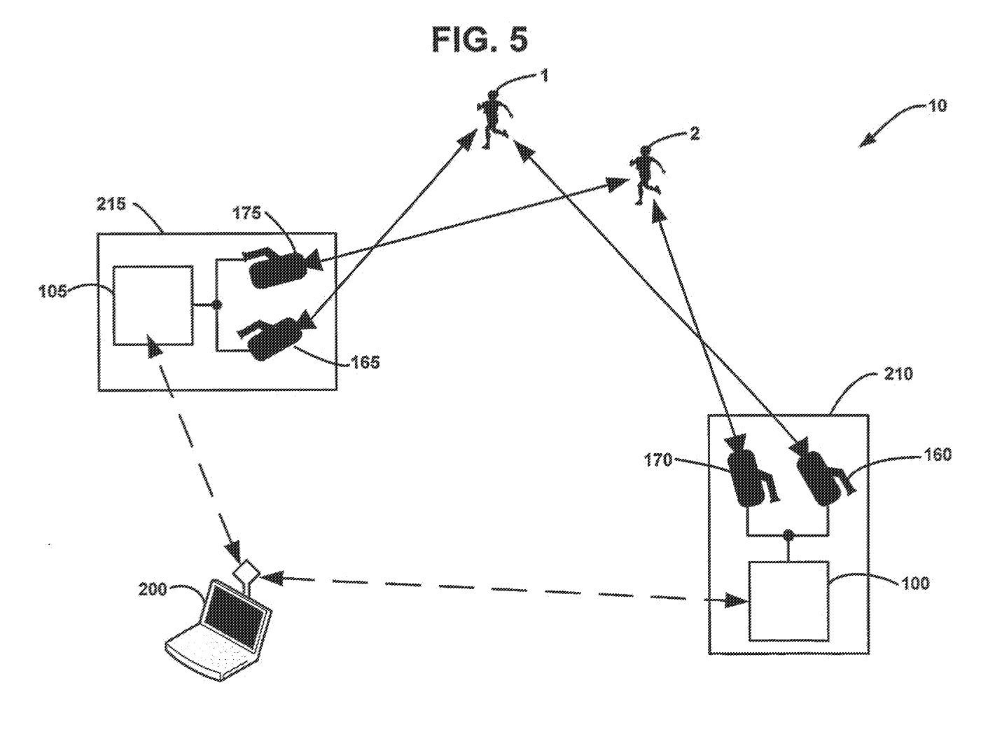

FIG. 5 shows a schematic diagram illustrating a multi camera bank embodiment according to a preferred embodiment of the present.

A camera bank refers to a unit comprising a base station, one or more positioners, and cameras attached to each positioner. Using this term, the system shown in FIG. 4 shows one camera bank. In a preferred embodiment hereof, one or more camera banks are controlled by a recording center. Automatic video recording system 10 of FIG. 5 shows two camera banks (210 and 215) each having two recording units. As shown in FIG. 5, two recording units 160 and 165 track and record competitor 1 and two recording units 170 and 175 track and record competitor 2. Recording units 160 and 170 are controlled by base station 100; recording units 165 and 175 are controlled by base station 105, as shown. A plurality of base stations may be controlled by recording center 200. Recording center 200 also receives video feeds from all cameras and uploads videos to central computers for further broadcasting, processing, and the like. Returning to FIG. 5, the multiplicity of camera banks (there may be more than two for larger competition venues) provides the ability to obtain simultaneous footage of a competitor up close and from a larger distance. Alternating between such views has great entertainment value.

Recording center 200 may be a computer and the scenario depicted in FIG. 5 (like those in FIG. 3 and FIG. 4) may be shown on the screen of that computer. A pointing device (mouse, or, in case of a touchscreen, a finger) may be used to control, i.e., establish and remove, connections between recording units and remote devices. The computer screen may show a realistic view of the relative locations of all recording units and remote devices to help the operator make decisions regarding the choosing of subjects for recording.

For large area venues, one or even two camera banks may not be sufficient for recording good footage when competitors are at a significant distance. The automatic video recording system may comprise several camera banks programmed such that different camera banks provide footage for broadcast from different areas of the venue. When all competitors happen to be in an area that is reached for filming by a single camera bank, if that camera bank has a single recording unit, the camera may have to zoom out to show multiple competitors.

Referring to FIG. 4 and FIG. 5, in accordance with one preferred embodiment hereof, the system is configured to record one or more of the multiple subjects that are within a particular geometrical region. In FIG. 4, competitor 1 is within the recordable region of recording unit 170, while competitor 5 is not. Additionally, it is noted that multiple recording units or camera banks may be set up at particular locations, such as, for example, along the beach at a surfing locale, a snow-skiing area, along a large kiteboarding area, etc. The recording units are preferably set up to record a particular geometrical region. Competitors (or subjects) wearing remote devices that enter the geometrical region will be tracked and recorded.

In another embodiment an athlete wears a remote device that allows a camera to remain pointed at and zoomed in at the athlete. The video from the camera is streamed, live or delayed, to a website so that viewers may watch the video over the Internet. This solves the problem of having stationary, preprogrammed, or manually adjusted webcams which inherently provide less interesting video footage (see the discussion above regarding surfcams). Current webcams are traditionally zoomed out or pre-programmed to zoom in and pan independently of the athlete's motion. According to a preferred embodiment hereof, the systems hereof keep a camera pointed at an athlete through camera pan, tilt, focus, zoom, or a combination thereof. This feature allows interested parties to view live or recorded sessions of the athlete. For example, current surfing webcams are zoomed out when pointed at the waves from the beach. In some cases they are pre-programmed to zoom in and pan across the waves independently of any surfer activity. This provides less interesting footage than if the camera was zoomed in and following a surfer surfing the waves. The systems and methods hereof allow a webcam to be zoomed in and follow a surfer while broadcasting the video feed over a network such as the Internet. Using the systems and methods of the present invention, recorded video greatly improves the informative quality communicated to viewers and increases the appeal of the recorded video. For example, using the systems and methods of the present invention, a detailed image of the break of the waves may be seen by potential site visitors.

The system may also post-process the videos before or during broadcast (possibly with some delay) and apply digital zoom to show more detail of scenes of interest. In one embodiment, digital zoom is controlled by image recognition software that recognizes the subject of the video. The video is preferably cropped and adjusted so that the subject appears in a preferred relative on-screen size (for example, the height of the subject fills one third of the screen) and in a preferred location on screen (for example, centered horizontally and vertically the on screen).

In some embodiments, global positioning antennas may be part of each recording unit. In other embodiments one global positioning antenna is included in a recording unit or camera bank. This is sufficient to determine the location of each camera when the relative locations of the cameras within the recording unit or camera bank are known, like in embodiments where all cameras of a recording unit are mounted on a common platform. In a preferred embodiment, a global positioning antenna is associated with each camera and a differential positioning technique is employed for computing pointing vectors between cameras and remote devices. In this embodiment the placement of each recording unit may be optimized for the particular event, terrain, and/or other local circumstances. The communication between a base station and associated recording units may be wireless, providing additional flexibility in the placement of the cameras.

There are various options for recording sound with the videos. In a preferred embodiment sound is recorded by an operator of the automatic video recording system at the base station. Preferably, the operator is able to comment on the visuals being recorded as a sportscaster would do explaining to viewers the events that are happening. The operator may also have the ability to add visuals to the videos in the form of tagging them with the names of the participants or other pertinent information. Automatic tagging of the videos with time countdowns and the like is also a preferred option. The operator may also add advertisements to a screen as appropriate. Additionally, a computer system may automatically display advertisements on the screen as well.

In a preferred embodiment sound is also recorded using a microphone integrated with each remote device. In those embodiments where there is no operator recorded sound, sound recorded from each remote device may be the only sound that accompanies each video. In an embodiment where sound is also recorded by the operator, there may be an option presented to the viewer to choose which sound source they wish to hear, or, as long as a single video is shown, the sound coming from the subject in the video may be played at a different volume than the sound recorded by the operator (for example, the sound recorded by the remote device may be played back at a lower volume than the sounds recorded by the operator). The viewer may also select the video of a particular competitor or participant to view and to listen.

In some embodiments, sound may be recorded by microphones integrated with the cameras. In such embodiments, special care is preferably taken to reduce noise generated by the mechanical and electromechanical components of the positioners. The positioners are preferably embedded in a sound-proofing polymer to reduce their noise.

In a preferred embodiment of the present invention scheduled recording of videos after setup of the equipment is made available. Using the program of the event, or competition, the operator preferably inputs data concerning the timing of each heat and makes sure that each participant is equipped with an appropriate remote device. The recording units are turned on and off by appropriate signals from the base station.

At events that employ electronic controlled displays and other mass communication tools to organize the heats and inform the audience of the status of the competition, the systems hereof may be communicatively coupled with the data feed of the electronic controlled displays to automatically adjust the recording schedule to any change in the schedule of the event, including any changes that may occur as the event takes place.

The footage and sound recorded is then sent (uploaded) to hubs that may provide them to individual viewers in real time (with minimal delay) in various formats. Alternatively, the video footage and sound may be saved for later viewing, editing, etc. The hubs may be website servers or other computer processing systems. The formats may include viewing multiple videos on split screens, also permitting the viewer to select a single stream for viewing. Processing may include tagging, selecting scenes, overlaying, etc. Formats may include running apps on mobile devices and may include special features for those who are at the site of the event. Those being on the site may be recognized by mapping apps on mobile devices that employ global positioning technology or by image recognition.

The competitors may also wear point-of-view cameras that record and provide point-of-view footage for the recorded event. The point-of-view cameras may be worn on the wearer's head or upper body or may be affixed to sporting equipment (such as, for example, a surfboard, bicycle, etc.). The cameras may be connected to or integrated with the remote devices and the remote devices may broadcast the point-of-view footage in real time to the associated base stations.

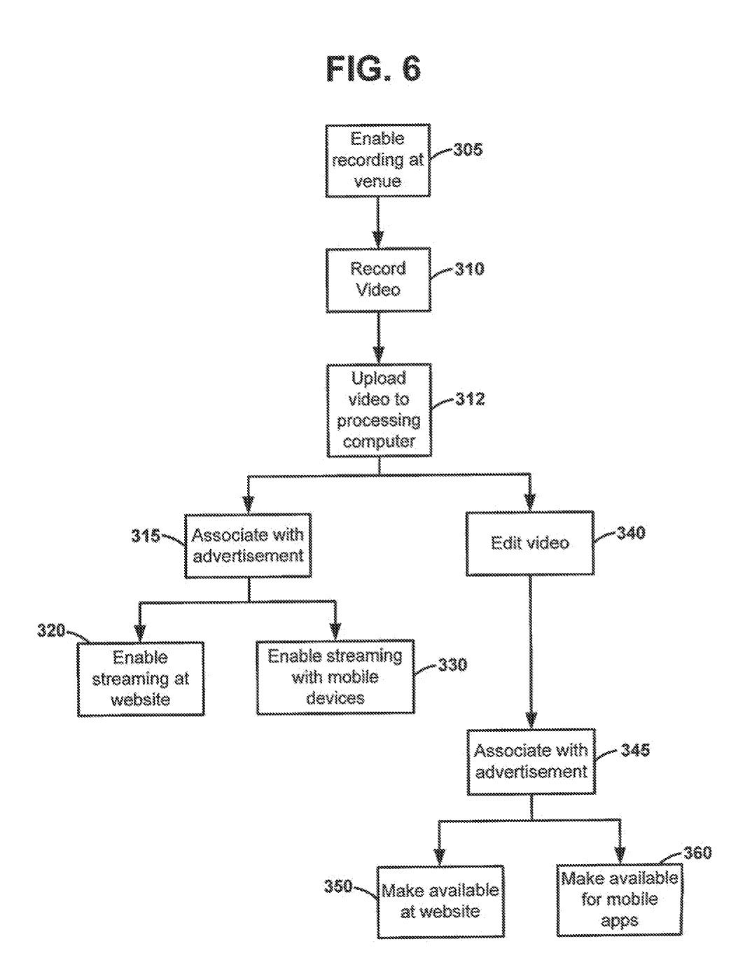

FIG. 6 shows a flowchart illustrating a method of using the automatic video recording systems of the present invention. According to a preferred embodiment hereof, method 300 uses automatic video recording systems wherein the cameras automatically stay oriented at a subject. The subject may be a specific surfer during a surfing session, a snowboarder, a kiteboarder, skateboarder, or soccer player, for example. The subject remains substantially in the view field of the camera because the camera automatically turns in the direction of the subject. Preferably, the velocity of the movements of the camera, as well as its focus and zoom, are adjusted so that optimal visual rendition of the subject's activities is captured. One such system is described in co-owned and co-pending U.S. patent application Ser. No. 13/726,203, titled “Portable System for High Quality Video Recording”, filed Dec. 23, 2012, such application hereby incorporated by reference herein in its entirety.

In method 300 of FIG. 6, a recording unit is set up at particular desired location or locations in step 305 (enable recording at venue). To record multiple participants, the following steps follow. With reference to the figures above, the recording system which is enabled in step 305 preferably comprises a base station, at least one recording unit, and a remote device for each participant. Each remote device used is collocated with a participant. To distinguish between the multiple participants being recorded, unique radio communication is established between each remote device and the base station. The remote devices used are able to determine their location using various location determination technologies discussed herein. As each participant moves in the environment, each participant's variable location data is communicated to the base station. Upon receipt of the location data, the base station computes variable camera orientations for each participant and determines the distance from each remote device to the recording unit. The base station sends commands to adjust the orientation, turning velocity, zoom and focus for each camera of each recording unit according to the participant's variable location and velocity. For a more detailed discussion of the implementation of these steps, refer to the co-owned and co-pending patent applications incorporated by reference above.

The camera or cameras of the recording unit record images of the activity at the location, step 310. The recorded footage (i.e., video and accompanying sound) are preferably uploaded to a processing computer in step 312. For multiple participants, the recorded images associated with that participant are identifiable from the recorded images of other participants; this identification may be based on input into a base station or into a recording center during programming of those devices for the recording session. In a preferred embodiment, the recorded activity is broadcast as streaming video on a web site in step 320 or made available to access through an application of mobile computing device (e.g., a smartphone or tablet computer) in step 330. Alternatively, the video may be saved and edited for content in step 340. For example, those scenes which are less compelling may be cut out. The edited video is then preferably made available for users of a dedicated website (i.e., a web site in which users register to access the website content) in step 350 or of dedicated mobile apps in step 360. Using the automated video recording systems, recording units, and camera banks described herein increases the informative value and entertainment value of the recorded videos whether streamed or edited for delayed or later viewing. It is therefore preferred to make available such content with relevant advertising. Advertising is associated both with streaming videos (step 315) and with videos edited and broadcast at a user's request (step 345). Applying this innovation provides value for advertisers advertising on web sites or on mobile devices that show surfcams and similar “condition cams” like those found at ski and snowboarding resorts.

Method 300 may be implemented by engaging professional or amateur sportsmen and sportswomen; such events may be advertised ahead of time for those who prefer the live (streaming video) broadcast. Professional or accomplished amateur sessions are more entertaining and more informative regarding the conditions and the experience at the venue of the session than simply showing the venue itself. Correspondingly, higher viewership is to be expected for such videos; this increases the value for advertisers. While traditional surfcams and other “condition cams” do attract some, usually local, advertisers, the video recordings made according to the present invention have the potential to attract more and more diverse advertisers.

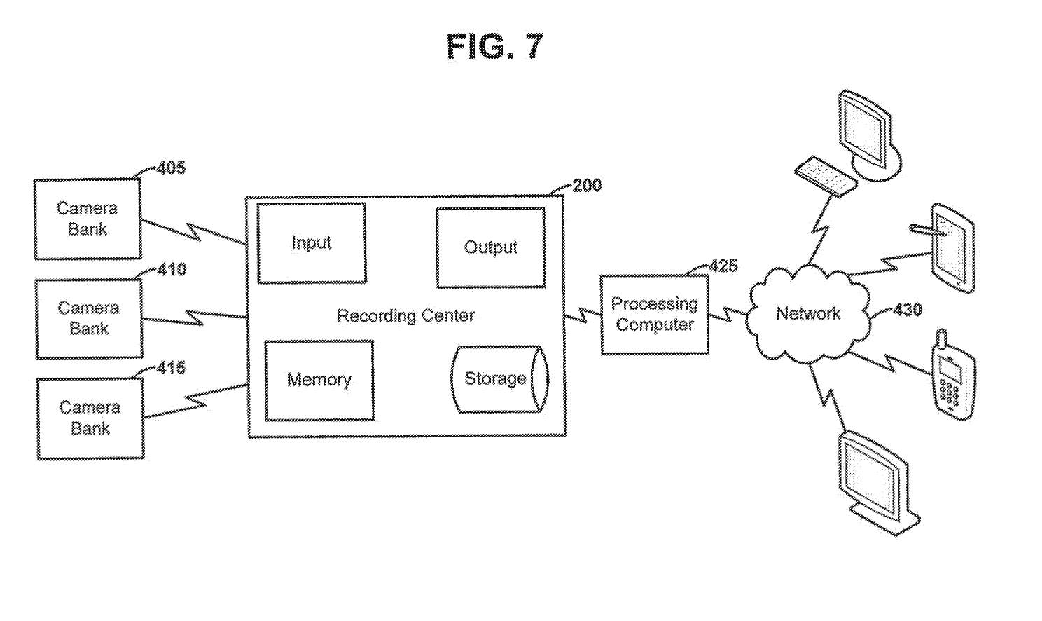

FIG. 7 shows a schematic diagram illustrating a recording center and its connected components according to a preferred embodiment of the present invention. In FIG. 7, several camera banks are shown (camera bank 405, 410, and 415). The number of camera banks may be increased or decreased as necessary. Each camera bank comprises one or more cameras and associated camera positioners to automatically track a subject as described above. The camera banks are communicatively coupled with recording center 200. The camera banks and recording center may be communicatively coupled in a number of ways, one such way using wireless network devices which may communicate over a wireless network. In one preferred embodiment, recording center 200 is a computer having input, output, memory, and storage. As noted above, recording center 200 receives video feeds from all cameras of the linked camera banks Recording center 200 is preferably configured with software to enable user control of camera banks, to permit user control of switching camera views, to permit selection of the multiple subjects or participants to be recorded by any of the recording units of any of the camera banks during any particular period of time, to permit user control of switching among competitors or subjects, and user control of other features as discussed herein. Additionally, recording center 200 may be used to choose which participant or participants to record among multiple participants who are within particular geometrical regions to be recorded by particular camera banks For example, recording center 200 preferably allows a user to select which camera bank will record a particular participant in a particular geometrical region. FIG. 5 shows camera bank 215 directed at competitor 1. If desired, camera bank 215 may be directed to record another competitor or subject that may enter the particular geometrical region where the camera banks are situated.

Recording center 200 is preferably connected with processing computer 425 having input, output, memory, and storage. Processing computer 425 enables streaming of recorded footage or is configured to permit storage and editing of recorded footage. Processing computer 425 is preferably connected to network 430 (such as the Internet) to permit access to the recorded footage by streaming or by user's accessing a web site. Processing computer 425 may include multiple computers, servers, etc. The video footage is accessible by way of a number of devices, as shown. For example, the video footage may be accessed by television, computer, smartphone, tablet computer, etc.

It is noted that while the figures illustrate a runner, the activities with which the system and methods of the present invention may be used are not in any way limited to running. Other activities have been mentioned herein; it is noted that the mention of these other activities does not limit those activities with which the systems and methods of the present invention may be used.

Different embodiments, features and methods of the invention are described with the aid of the figures, however the particular described embodiments, features and methods should not be construed as being the only ones that constitute the practice of the invention and the described embodiments, features and methods are in no way substitutes for the broadest interpretation of the invention as claimed.

What is claimed is:

1. A system for automatic video recording of multiple subjects, said system comprising: a plurality of remote devices, a base station, and at least one recording unit, wherein each one of said plurality of remote devices is collocated with one of the multiple subjects, each one of said plurality of remote devices is communicatively coupled with said base station, and said base station controls said at least one recording unit.

2. The system of claim 1, wherein said at least one recording unit comprises a positioner and a camera that is oriented by said positioner.

3. The system of claim 2, wherein said base station is communicatively coupled with said camera.

4. The system of claim 2, wherein said base station is communicatively coupled with said positioner.

5. The system of claim 1, wherein the number of recording units is less than the number of subjects and wherein said system records, at any given time, one or more subjects that have been chosen for recording.

6. The system of claim 1, wherein said base station is used to select among the multiple subjects one or more who are to be recorded by said at least one recording unit during any particular period of time.

7. The system of claim 1, wherein said base station commands said at least one recording unit to record one or more of the multiple subjects that are within a particular geometrical region.

8. A system for recording a sporting event with multiple participants, said system comprising: one or more camera banks, wherein each said camera bank comprises at least one recording unit, said at least one recording unit comprising at least one camera, wherein said at least one camera of said at least one recording unit is capable of being automatically oriented at one or more of the multiple participants, and wherein said camera banks are controlled by a recording center communicatively coupled with said camera banks.

9. The system of claim 8, wherein said at least one camera is capable of being automatically focused and zoomed.

10. The system of claim 8, wherein said recording center is used to select among the multiple participants to be recorded by any of said recording units of any of said camera banks during any particular period of time.

11. The system of claim 8, wherein said recording center is programmed to choose among the multiple participants those who are within particular geometrical regions to be recorded by particular camera banks.

12. The system of claim 8, wherein said recording center is programmed to receive and store footage recorded by said camera banks.

13. The system of claim 12, wherein said recording center is communicatively coupled to other computers for uploading footage recorded, whereby the footage is made available for remote viewing.

14. The system of claim 13, wherein the footage is uploaded to a processing computer, and wherein said processing computer is further used to enable streaming videos uploaded from said recording center.

15. The system of claim 14, wherein the footage uploaded to the processing computer is edited before it is made available for remote viewing.

16. A method of automatically recording a sporting event with at least one participant, wherein the location of the at least one participant is variable during recording, said method comprising the steps of:
a) enabling recording by a recording system comprising a base station, at least one recording unit, and a remote device for, and collocated with, each participant;
b) establishing unique communication between each remote device and the base station;
c) communicating each participant's variable location data to the base station;
d) computing variable camera orientations and recording-unit-to-remote-device distances for each participant;
e) sending commands from the base station for adjusting orientation, turning velocity, zoom, and focus for each recording unit according to each participant's variable location and velocity;
f) recording images of at least one participant at variable locations.

17. The method of claim 16, further comprising the step of uploading the recorded images to at least one computer for live distribution to viewers and for saving the recorded images.

18. The method of claim 17, further comprising the step of editing the recorded images.

19. The method of claim 18, further comprising the step of associating advertisements with the recorded images.

20. The method of claim 17, wherein an advertisement is added to images distributed as live images.
